(19) United States
(12) Patent Application Publication
(10) Pub. No.: US 2021/0277264 A1
(43) Pub. Date: Sep. 9, 2021

(54) INK COMPOSITIONS

(71) Applicant: HEWLETT-PACKARD DEVELOPMENT COMPANY, L.P., Spring, TX (US)

(72) Inventors: Jayprakash C. Bhatt, Corvallis, OR (US); Kellie Seetho Dalby, Corvallis, OR (US); Tayo Olu Yolemi, San Diego, CA (US)

(21) Appl. No.: 16/605,250

(22) PCT Filed: Jun. 11, 2018
(86) PCT No.: PCT/US2018/036802

§ 371 Date: Oct. 15, 2019

(51) Int. Cl. C09D 11/107; C09D 11/40; C09D 11/326; C09D 11/322; C09D 11/102; B41M 5/00

(52) U.S. Cl. CPC C09D 11/107; C09D 11/40; B41M 5/0023; C09D 11/322; C09D 11/102; C09D 11/326

(57) ABSTRACT

An ink composition can include water, from 1 wt % to 6 wt % organic pigment, from 0.1 wt % to 3 wt % styrene acrylic resin dispersant having an acid number ranging from 100 mg KOH/g to 160 mg KOH/g, and from 1 wt % to less than 5 wt % organic co-solvent.

### BACKGROUND

Inkjet printing has become a popular way of recording images on various types of media. Some of the reasons include low printer noise, variable content recording, capability of high speed recording, and multi-color recording. These advantages can be obtained at a relatively low price to consumers. As the popularity of inkjet printing increases, the types of uses also increase providing demand for new ink compositions and applications.

### BRIEF DESCRIPTION OF THE DRAWINGS

FIG. 1 graphically depicts an example method of printing in accordance with the present disclosure;

FIG. 2 graphically illustrates an example of jetting an ink composition(s) from an ink set on to a printable liner in accordance with the present disclosure; and

FIG. 3 graphically illustrates hot corrugation where an example printable liner is adhered to a flute in order to form a printed corrugated article.

### DETAILED DESCRIPTION

Ink compositions utilized in aqueous inkjet printing often contain greater than 10 wt % of a high boiling point, water-soluble, organic co-solvent. The incorporation of organic co-solvent at this concentration can provide good jetting reliability, particularly in more sensitive process such as in thermal inkjet printing technologies. In some instances, these concentrations can adversely affect print durability. Thus, typically a balance between durability and printability, e.g., decap, kogation, nozzle health, etc., is struck. With durability in mind which may occur at the expense of printability, durability that is too low can be a bigger issue when printing on media that may undergo harsh printing conditions, e.g., printing on printable packaging liners for subsequent application to a flute of a corrugated article using a hot corrugation process. Furthermore, even if printed on the corrugated article after pre-assembly of the printable liner with the flute, packaging material is often exposed to harsh conditions during handling, e.g., shipping, etc., where there may be ample opportunity for the printed images to be damaged.

In accordance with the present disclosure, an ink composition can include water, from 1 wt % to less than 5 wt % organic co-solvent, from 1 wt % to 6 wt % organic pigment, and from 0.1 wt % to 3 wt % styrene acrylic resin dispersant. The styrene acrylic resin dispersant can have an acid number from 100 mg KOH/g to 160 mg KOH/g. In one example, the water content of the ink composition can be from 90 wt % to 97 wt %. In another example, the organic co-solvent can include a lactam. In still another example, the organic co-solvent can include a hydroxyethyl group. In yet another example, the organic co-solvent can have a partition coefficient ranging (Log P_{1-octanol/water}) from −1.4 to −0.1. Example organic co-solvents that can be used includes 2-pyrrolidinone, 2-hydroxyethyl 2-pyrrolidinone, 5.5-dimethyl hydantoin, ethylhydroxy propanediol, di-(2-hydroxyethy)-5.5-dimethylhydantoin, triethylene glycol, or a combination thereof. In another example, the organic co-solvent can be a combination of 2-hydroxyethyl 2-pyrrolidinone and di-(2-hydroxyethy)-5.5-dimethylhydantoin. The styrene acrylic resin dispersant and the organic pigment can be present at a weight ratio from 1:10 to 1:2. In another example, the ink composition can further include from 0.3 wt % to 2 wt % polyurethane binder. The ink composition can also include a chelating agent. The chelating agent can be selected from 1,3-propylenediiaminetetraacetic acid, ethylenediamine-N,N-disuccinic acid trisodium salt, glutamic acid, N,N-diacetic acid, alpha-alaninediacetic acid trisodium salt, ethyl diglycol, disodium ethanoldiglycine, 4,5-dihydroxy-1,3-benzenesulfonic acid, or a combination thereof.

In another example, an ink set can include a colored ink and a black ink. The colored ink can include water, from 1 wt % to less than 5 wt % organic co-solvent, from 1 wt % to 6 wt % organic pigment, and from 0.1 wt % to 3 wt % styrene acrylic resin dispersant. The styrene acrylic resin dispersant can have an acid number that can range from 100 mg KOH/g to 160 mg KOH/g. The black ink can include water, a carbon black pigment, and a dispersant. In one example, a water content of the colored ink can be from 90 wt % to 97 wt %. In another example, the dispersant for the carbon black pigment can be a styrene resin acrylic dispersant having an acid number ranging from 100 mg KOH/g to 160 mg KOH/g.

Furthermore, a method of printing can include jetting an ink composition onto a media substrate. The ink composition can include water, from 1 wt % to less than 5 wt % organic co-solvent, from 1 wt % to 6 wt % organic pigment, and from 0.1 wt % to 3 wt % styrene acrylic resin dispersant. The styrene acrylic resin dispersant can have an acid number that can range from 100 mg KOH/g to 160 mg KOH/g. In one example, the media substrate can be a printable liner and the method can further include applying the printable liner to a flute of a corrugated article using a hot corrugation process at from 140° C. to 220° C.

It is noted that when discussing the ink composition, the ink set, or the method of printing herein, each of these discussions can be considered applicable to one another whether or not they are explicitly discussed in the context of that example. Thus, for example, when discussing an organic co-solvent related to the ink composition, such disclosure is also relevant to and directly supported in the context of the ink set, the method of printing, and vice versa.

The ink composition can be an aqueous ink composition. Water can be the primary solvent and can make up a significant portion of the ink composition. In one example, the water can be present in the ink composition at from 90 wt % to 97 wt %. In another example, the water can be present at from 91 wt % to 96 wt %, from 91 wt % to 95 wt %, from 92 wt % to 95 wt %, or from 92 wt % to 94 wt %. In some examples, the water can be deionized, purified, or a combination of purified and deionized.

The ink composition can further include an organic co-solvent. In one example, the organic co-solvent can include a lactam. In another example, the organic co-solvent can include a hydroxyethyl group. The hydroxyethyl group can contribute to the hydrophilic nature of the organic co-solvent. In still other examples, the organic co-solvent can be both a lactam and include a hydroxyethyl group, e.g., 2-hydroxyethyl-2-pyrollidinone.

Organic co-solvents with higher hydrophilicity can provide good results with respect to printability, and because low organic co-solvent concentrations can be used, enhanced good durability can be achieved in many instances. The hydrophilicity of the organic co-solvent can be quantified as a partition coefficient. As used herein, “partition coefficient” refers to a concentration ratio of a compound in an equilibrium mixture of two immiscible phases, and can be a measure of the difference in solubility of the compound in the two immiscible phases. Formula I provides an equation of quantifying the hydrophilicity of the organic co-solvents of the present disclosure, as follows:

$$log P ( 1 - \frac{octanol}{water} ) = log \frac{[ solute ] unionized - octanol}{[ solute ] unionized water} \qquad ( I )$$

In some examples, the organic co-solvent can have a partition coefficient ranging from −1.4 log P_{1-octanol/water} to −0.1 log P_{1-octanol/water}. Some example organic co-solvents and their corresponding partition coefficients in an equilibrium mixture of 1-octanol (partition coefficient of 2.34) and water (partition coefficient of −0.825) are shown in Table 1 below.

TABLE 1
Co-solvent and Partition Coefficient (log P_{1-octanol/water})

| | Partition |
|---|---|
| Solvent | Coefficient |
| di-(2-hydroxyethy)-5,5-dimethylhydantoin | −1.39 |
| triethylene glycol | −1.00 |
| ethylhydroxy propanediol | −0.50 |
| N-(2-hydroxyethyl)-2-pyrrolidinone | −0.40 |
| 5,5-dimethyl hydantoin | −0.40 |
| 2-pyrrolidone | −0.10 |
| ethyl alcohol | 0.00 |
| butyl alcohol | 0.78 |

As noted, organic co-solvents ethyl alcohol and butyl alcohol are not within the partition coefficient range of −1.4 to −0.1 and thus, may not provide as much benefit of some of the other organic co-solvents that do fall within this range. Thus, in examples of the present disclosure, the organic co-solvent can include 2-pyrrolidinone, N-(2-hydroxyethyl)-2-pyrrolidinone, 5,5-dimethyl hydantoin, ethylhydroxy propanediol, triethylene glycol, di-(2-hydroxyethy)-5,5-dimethylhydantoin, or a combination thereof. In one specific example, the organic co-solvent can be a combination of 2-hydroxyethyl 2-pyrrolidinone and di-(2-hydroxyethy)-5.5-dimethylhydantoin. In yet other examples, the organic co-solvent can be 2-pyrrolidinone, 2-hydroxyethyl 2-pyrrolidinone, di-(2-hydroxyethy)-5.5-dimethylhydantoin, triethylene glycol, or a combination thereof. In a further example, the organic co-solvent can be 2-pyrrolidinone, 2-hydroxyethyl 2-pyrrolidinone, or a combination thereof. In another example, the organic co-solvent can be 5,5-dimethyl hydantoin, di-(2-hydroxyethy)-5.5-dimethylhydantoin, or a combination thereof. In yet another example, the organic co-solvent can be 2-hydroxyethyl 2-pyrrolidinone, di-(2-hydroxyethy)-5.5-dimethylhydantoin, triethylene glycol, or a combination thereof.

The organic co-solvent can be hydrophilic and can reduce the incidence of nozzle blockage due to the formation of a viscous plug. The reduced incidence of nozzle blockage can contribute to nozzle health, and in some examples, improved decap performance.

The organic co-solvent can be present in the ink composition at from 1 wt % to less than 5 wt %. Thus, when referring to the organic co-solvent in the ink compositions, ink sets, and methods described herein, it is noted that the organic co-solvent concentration ranges provided refer to a total organic co-solvent content, e.g., cumulative of all organic co-solvent added to the other aqueous vehicle components in the ink composition. In accordance with this, the organic co-solvent content can alternatively be present at from 2 wt % to 4 wt %, from 1 wt % to 4.9 wt %, from 1 wt % to 4.5 wt %, from 3 wt % to 4.5 wt %, from 2 wt % to 3.5 wt %, or from 2.5 wt % to 4.5 wt %. That stated, additives such as surfactant, polymer, oligomer, latex particles, salts, emulsifiers, etc., are not counted as “organic co-solvents.”

The organic pigment is not particularly limited, but excludes inorganic pigments, such as inorganic carbon black pigment. The particular pigment used will depend on the color properties to be generated by the colorist in creating the ink composition. Pigment colorants can include cyan, magenta, yellow, red, blue, orange, violet, green, blue, pink, etc. In one example the organic pigment can be a cyan pigment, a magenta pigment, a yellow pigment, or a combination thereof. In another example, the organic pigment can be a green pigment, an orange pigment, a violet pigment, or a combination thereof. It is noted that ink compositions can include more than one pigment, such as a red ink containing magenta and yellow pigment, or a magenta ink with magenta pigment and a small amount of yellow pigment to adjust the color properties (hue angle), etc. In still other examples, an ink set may include one or more ink composition as described herein, and other ink compositions of the ink set may be outside the scope of the claimed ink compositions set forth herein. For example, an ink set may include a black ink with an inorganic pigment, a cyan ink, a magenta ink, and a yellow ink with dispersant resins outside of the 100 mg KOH/g to 160 mg KOH/g acid number range, and perhaps only the orange ink, the violet ink, and/or the green ink include organic colored pigments with low organic co-solvent content and styrene acrylic resin dispersant having an acid value from 100 mg KOH/g to 160 mg KOH/g. For example, there may be reasons to formulate the ink set in this manner, such as for example when working with some organic pigments that may be more sensitive to instability with higher acid number styrene acrylic resin dispersants, e.g., some perinone and other pigments.

In further detail, suitable organic pigments can include, for example, azo pigments including diazo pigments and monoazo pigments; polycyclic pigments (e.g., phthalocyanine pigments such as phthalocyanine blues and phthalocyanine greens, perylene pigments, perinone pigments, anthraquinone pigments, quinacridone pigments, dioxazine pigments, thioindigo pigments, isoindolinone pigments, pyranthrone pigments, and quinophthalone pigments); nitro pigments; nitroso pigments; anthanthrone pigments; or a combination thereof.

Representative examples of phthalocyanine blues and greens can include copper phthalocyanine blue, copper phthalocyanine green and derivatives thereof such as Pigment Blue 15, Pigment Blue 15:3, and Pigment Green 36. Representative examples of perylene pigments can include Pigment Red 123, Pigment Red 190, Pigment Red 189, and Pigment Red 224. Representative examples of a perinone pigments can include Pigment Orange 43 and Pigment Red 194. Representative examples of anthraquinone pigments can include Pigment Red 43, Pigment Red 194, Pigment Red 177, Pigment Red 216, and Pigment Red 226. Representative examples of quinacridone pigments can include Pigment Orange 48, Pigment Orange 49, Pigment Red 122, Pigment Red 192, Pigment Red 202, Pigment Red 206, Pigment Red 209, Pigment Violet 19, and Pigment Violet 42. Representative examples of dioxazine pigments can include Pigment Violet 23 and Pigment Violet 37. Representative examples of thioindigo pigments can include Pigment Red 86, Pigment Red 87, Pigment Red 198, Pigment Violet 36, and Pigment Violet 38. Representative examples of heterocyclic yellows include Pigment Yellow 1, Pigment Yellow 12, Pigment Yellow 13, Pigment Yellow 14, Pigment Yellow 17, Pigment Yellow 73, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Other pigments that can be used include DIC-QA Magenta Pigment, Pigment Red 150, and Pigment Yellow 74. The above pigments can be commercially available in powder, press cake, or dispersions form from a number of sources. If the colorist desires, two or more pigments can be combined to create a color that provides truer color mixing within an ink set, or for some other purpose.

The organic pigment can be present in the ink composition at from 1 wt % to 6 wt %. In yet other examples, the organic pigment can be present in the ink composition from 1 wt % to 4 wt %, from 2 wt % to 5 wt %, or from 2 wt % to 5.5 wt %.

The organic pigment can be dispersed by a styrene acrylic resin dispersant having an acid number ranging from 100 mg KOH/g to 160 mg KOH/g. In other examples, the styrene acrylic resin can have an acid number ranging from 110 mg KOH/g to 155 mg KOH/g, from 100 mg KOH/g to 130 mg KOH/g, or from 140 mg KOH/g to 160 mg KOH/g. This acid number or acid value range can play a role in pigment stability, particle size over time, particle agglomeration, and other undesirable attributes with some organic pigments (See Example 3 for stability data related to Pigment Orange 43). Particle agglomeration over time can negatively affect the viscosity, stability, and jettability of the ink composition. The association of the styrene acrylic resin dispersant with a surface of the pigment, e.g., adsorption, hydrogen bonding, or other similar attractions with the surface of the organic pigment, can also be impacted by the acid number. As a note, “particle agglomeration” refers to an increase in a cumulative particle size as particles adhere to each other. “Particle size” refers to the diameter of spherical particles, or to the longest dimension of non-spherical particles. When referring to particle agglomeration, the cumulative particle size refers to the diameter of a spherical grouping of particles, or the longest dimension of a non-spherical grouping of particles.

In some examples, the styrene acrylic resin dispersant can have a weight average molecular weight ranging from 5,000 Mw to 18,000 Mw. In other examples, the styrene acrylic resin dispersant can have a weight average molecular weight ranging from 8,000 Mw to 14,000 Mw, or from 9,000 Mw to 12,000 Mw. The styrene acrylic resin and the organic pigment can be present in the ink composition at a weight ratio from 1:10 to 1:2. In other examples, a weight ratio of the styrene acrylic resin and the organic pigment can be from 3:20 to 1:2, from 1:7 to 1:2, or from 1:10 to 1:3.

In some examples, the ink composition can further include a polyurethane binder. In one example the polyurethane binder can be present in the ink composition at from 0.3 wt % to 2 wt %. In yet other examples, the polyurethane binder can be present in the ink composition at from 0.5 wt % to 1 wt % or from 0.4 wt % to 0.8 wt %. The polyurethane binder can be a linear polyurethane, a graft polyurethane copolymer, or a combination thereof. In some aspects, the graft polyurethane copolymer binder outperformed the linear polyurethane copolymer binder with respect to decap performance and to some extent nozzle health, but both exhibit good durability and can be inkjetted using various types of printing architecture. Example polyurethane copolymer resins that can be used include Hydran® polyurethane copolymer resins available from DIC, Japan, e.g., RW4601 (straight-chain polyurethane) or RW7581 (graft polyurethane).

Linear polyurethane copolymer binders can be prepared by reacting a polyisocyanate, e.g., such as a diisocyanate, with a polyol (or multiple polyols). The polyol can react with the polyisocyanate to contribute to the formation of a polyurethane copolymer chain that does not include side groups. Graft polyurethane copolymer binders of the present disclosure can have a comb-like structure with a main chain (e.g., backbone or “comb handle”) with side chains (e.g., “comb teeth”) grafted to the main chain. In one specific example, the graft polyurethane copolymer can include a main chain of polyurethane and a grafted side chains of a vinyl polymer. Graft polyurethane copolymer binders can also be prepared by reacting a polyisocyanate, e.g., a diisocyanate, with multiple types of polyols. In either case, the term “polyol” indicates that the compound includes multiple hydroxyl groups, e.g., 2 or more hydroxyl groups. In some examples, the polyol can be a polyether polyol, a polyester polyol, a polyester ether polyol, a polycarbonate polyol, or mixtures thereof. The term “polyisocyanate” indicates the presence of multiple isocyanate groups, such as a diisocyanate, a triisocyanate, or other compounds with isocyanate groups that may have even more than three isocyanate groups. The term “poly” in these contexts does not specifically infer that the compound is a polymer.

In further detail, a polyurethane copolymer binder can be a urethane resin with a hydrophilic group, and can further include an acetylene compound. The acetylene compound can include an alkylene oxide adduct of an acetylene glycol or an alkylene oxide adduct of an acetylene monoalcohol. The alkylene oxide can be an ethylene oxide, for example. In one example, the acetylene compound may be an alkylene oxide adduct of an acetylene glycol and the alkylene oxide may include an ethylene oxide. The linear polyurethane copolymer binder can be prepared by reacting a polyol containing a hydrophilic group with a polyisocyanate, e.g., a diisocyanate. The acetylene compound can be present at relatively small concentrations, e.g., from 0.001 wt % to 1 wt % (or up to 0.5 wt % in one example) based on the components forming the polyurethane copolymer binder. A cationic group or an anionic group can be included as the hydrophilic group. If an anionic group, the hydrophilic group can include carboxyl group (carboxylic acid) and a carboxylate group (salt or ester of carboxylic acid).

In another example, a graft polyurethane copolymer binder can include a main chain of polyurethane and grafted side chains of a vinyl polymer. For example, the graft polyurethane copolymer can be prepared by reacting a polyisocyanate with multiple types of polyols, namely a first (type) polyol and a second (type) polyol. The first polyol can contribute to the formation of the side chains by reacting with the polyisocyanate and second polyol in a polymerization batch or other polymerization processing methodology. The second polyol, on the other hand, can react with the polyisocyanate to contribute to the formation of the main chain of the graft polyurethane copolymer. The term “polyol” indicates that the compound includes multiple hydroxyl groups, e.g., 2 or more hydroxyl groups. The first polyol can be a vinyl polymer with multiple hydroxyl groups at one end of the polymer, e.g. on one side of the vinyl group. The vinyl polymer with the multiple hydroxyl groups at one end thereof can react with the other polymerization components to form the side chains, thus providing the graft polyurethane copolymer with the “comb-like” structure. The second polyol can be, for example, a polyether polyol, a polyester polyol, a polyester ether polyol, a polycarbonate polyol, or mixtures thereof. Other types of polyols (other than those listed as the second polyol) may also be included, as can be beneficial for the reaction with the polyisocyanate. In some more specific examples, a chain extender compound can be used in the preparation of the graft polyurethane copolymer.

The first polyol, can be a vinyl polymer having two hydroxyl groups at one end and can be included as a reactant at from 1 wt % to 70 wt %, or from 5 wt % to 50 wt % based on the weight of the other major reactants used to prepare the graft polyurethane copolymer, e.g., the second polyol type in total content by weight, the first polyol type in total content by weight (vinyl polymer two hydroxyls on a single side of the polymer), any other polyols that may be present in total content by weight, the polyisocyanate in total content by weight, and a chain extender in total content by weight if one is included. Other components, such as liquids or other additives are not considered in calculating the weight percent of a specific component in the graft polyurethane copolymer.

In further detail, the first polyol can have a number average molecular weight from 500 Mn to 10,000 Mn. The first polyol can be prepared by reacting a vinyl monomer with a chain transfer agent having two hydroxyl groups and one mercapto group, for example. Other compounds or molecular arrangements can likewise be used to generate the second polyol with two hydroxyl groups positioned on one side of a vinyl group. In further detail, the vinyl monomer can include, for example, (meth)acrylic acid, (meth)acrylic acid alkyl ester, or a combination thereof. Other monomers can likewise be present.

The second polyol can be included as a reactant at from 5 wt % to 80 wt %, or from 5 wt % to 50 wt % based on the weight of the other major reactants used to prepare the graft polyurethane copolymer (major reactants defined the same as with respect to the first polyol weight percentage range). As mentioned, the second polyol can be a polyether polyol, a polyester polyol, a polyester ether polyol, a polycarbonate polyol, or mixtures thereof. In one example, the second polyol can have a number-average molecular weight of 500 Mn to 10,000 Mn. In another example, the second polyol can be a polyoxyalkylene glycol.

If other polyols are used, examples can include polyols with hydrophilic groups with anionic moieties, e.g., carboxyl groups, sulfonic acid groups, etc. There can also be polyols with cationic groups, e.g., tertiary amines. In some examples, some or all of the hydrophilic groups of the polyurethane can be quaternized or neutralized to provide the graft polyurethane copolymer with good dispersibility. Neutralization can occur by adding, for example, ammonia, organic amines having a boiling point of 200° C. or higher, e.g., triethylamine, morpholine, monoethanolamine, diethylethanolamine, etc., metal hydroxides, e.g., NaOH, KOH, LiOH, etc., at molar range of 0.5 to 3 (basic compound to anionic group). Cationic groups can likewise be neutralized, such as by an organic acid.

The polyisocyanate can be included as a reactant at from 5 wt % to 30 wt %. Examples of the polyisocyanate compounds that can be used include aromatic polyisocyanates such as 4,4′-diphenylmethane diisocyanate, 2,4′-diphenylmethane diisocyanate, carbodiimide-modified diphenylmethane diisocyanate, crude diphenylmethane diisocyanate, phenylene diisocyanate, tolylene diisocyanate, and/or naphthalene diisocyanate, aliphatic polyisocyanates and polyisocyanates having an alicyclic structure, such as hexamethylene diisocyanate, lysine diisocyanate, cyclohexane diisocyanate, isophorone diisocyanate, dicyclohexylmethane diisocyanate, xylylene diisocyanate, and/or tetramethylxylylene diisocyanate.

If a chain extender is present, reaction between the various polyols and the polyisocyanate can be charged in water, and a chain extender may be added for interaction with the graft polyurethane copolymer. The chain extender can be a polyamine, e.g., a diamine such as ethylenediamine. Other examples can include 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, and 1,4-cyclohexanediamine, N-hydroxymethylaminoethylamine, N-hydroxyethylaminoethylamine, N-hydroxypropylaminopropylamine, N-ethylaminoethylamine, N-methylaminopropylamine, diethylenetriamine, dipropylenetriamine, triethylenetetramine, hydrazine, N,N′-dimethylhydrazine, 1,6-hexamethylenebishydrazine, succinic acid dihydrazide, adipic acid dihydrazide, glutaric acid dihydrazide, sebacic acid dihydrazide, and isophthalic acid dihydrazide, β-semicarbazide propionic acid hydrazide, 3-semicarbazide-propyl-carbazate, and/or semicarbazide-3-semicarbazidemethyl-3,5,5-trimethylcyclohexane. Among these, ethylenediamine is preferably used. The chain extend can alternatively be a glycol and/or a phenol. The chain extended can be added at an equivalent ratio of chain extender amino groups in the polyamine to excess isocyanate groups at of the graft polyurethane copolymer can be 1.9 or less, or 1 or less, for example.

Once formed, the graft polyurethane copolymer can include an anionic group and a cationic group. For example, the graft polyurethane copolymer can include a carboxyl group with an anionic group derived from 2,2-dimethylol propionic acid, 2,2′-dimethylol butanoic acid, or both. The graft polyurethane copolymer can, for example, have a weight-average molecular weight when formed ranging from 10,000 Mw to 150,000 Mw, though molecular weights outside of this range can also be used in some examples. In the context of thermal inkjet printing, a weight average molecular weight from 10,000 Mw to 100,000 Mw, or from 15,000 Mw to 50,000 Mw can be a practical range to consider in formulating the ink compositions with low organic co-solvent content as described herein.

It is noted that other polyurethane copolymer binder preparation methodologies and formulations can be used to prepare either linear or graft polyurethane copolymer binders for use in conjunction with the ink compositions, ink sets, and/or methods described herein.

Various other additives can be included in the ink compositions to enhance properties of the ink composition for specific applications. Examples of these additives can include, but are not limited to, additional polymers, chelating/sequestering agents, surfactants, antimicrobial agents, UV absorbers, pH buffers, viscosity modifiers, and/or other additives. These are not considered when calculating the organic co-solvent concentration.

If chelating agent is included, the chelating agent can be selected from 1,3-propylenediiaminetetraacetic acid, ethylenediamine-N,N-disuccinic acid trisodium salt, glutamic acid, N,N-diacetic acid, alpha-alaninediacetic acid trisodium salt, ethyl diglycol, disodium ethanoldiglycine, 4,5-dihydroxy-1,3-benzenesulfonic acid, or a combination thereof. In one example, the chelating agent can include 1,3-propylenediiaminetetraacetic acid. The chelating agent can be present at from 0.001 wt % to 1 wt %, from 0.05 wt % to 0.5 wt %, or from 0.005 wt % to 0.1 wt %. If a surfactant is included, examples can include SURFYNOL® SEF, SURFYNOL® 104, or SURFYNOL® 440 (Evonik Industries AG, Germany); CRODAFOS™ N3 Acid or BRIJ® 010 (Croda International Plc., Great Britain); TERGITOL® TMN6, TERGITOL® 15S5, TERGITOL® 15S7, DOWFAX® 2A1, or DOWFAX® 8390 (Dow, USA); or a combination thereof. The surfactant or combinations of surfactants can be present in the ink composition at from 0.1 wt % to 5 wt % and, and in some examples, can be present at from 1 wt % to 3 wt %. With respect to the antimicrobial, any compound suitable to inhibit the growth of harmful microorganisms can be included. These additives may be biocides, fungicides, and other microbial agents. Examples of suitable microbial agents can include, but are not limited to, ACTICIDE® B20, ACTICIDE® M20 (both from Thor Specialties Inc., USA), NUOSEPT™ (Ashland Specialty Ingredients, China), UCARCIDE™ (Union Carbide Corp., USA), VANCIDE® (R.T. Vanderbilt Co., USA), PROXEL™ (ICI Americas Inc., USA), or a combination thereof. When present, additives to inhibit the growth of harmful microorganisms can be present at from 0.1 wt % to 3 wt % or from 0.1 wt % to 0.5 wt %, for example.

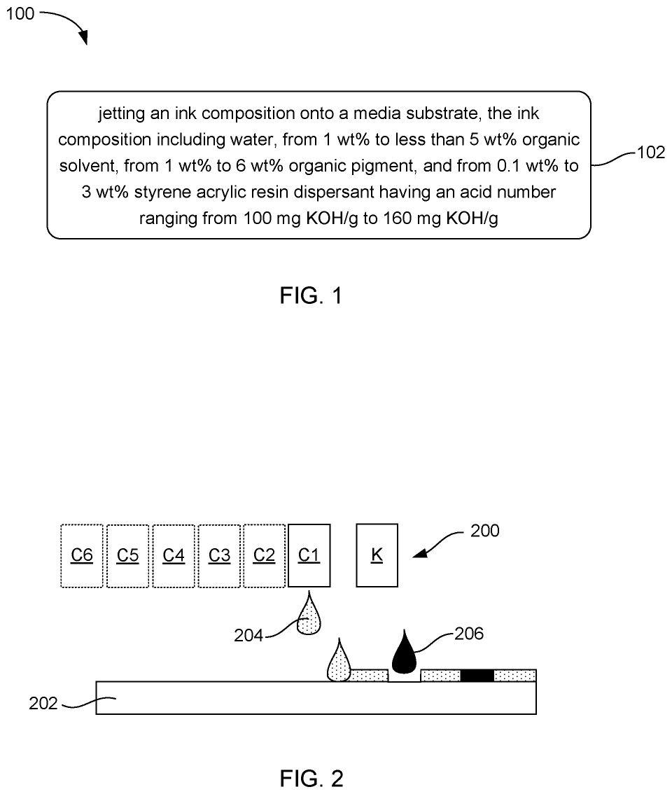

Turning now to FIG. 1, a method of printing 100 can include jetting 102 an ink composition onto a media substrate. The ink composition can include water, from 1 wt % to less than 5 wt % organic co-solvent, from 1 wt % to 6 wt % organic pigment, and from 0.1 wt % to 3 wt % styrene acrylic resin dispersant. The styrene acrylic resin dispersant can have an acid number that can range from 100 mg KOH/g to 160 mg KOH/g. The media substrate is not particularly limited and can be any printable substrate, including but not limited to, paper, specialty paper such as photo paper and/or coated paper, fabric, vinyl, printable liners for corrugated articles, pre-manufactured corrugated articles, etc. However, in one example, media substrate can be a printable liner and the method can further include applying the printable liner to a flute of a corrugated article using a hot corrugation process at temperatures from 140° C. to 220° C. In other examples, the printable liners can be used in connection with corrugated articles, such as containerboard corrugated packaging and corrugated signage. The printable liner can be first printed upon and then applied to the flute of the corrugated (directly applied to the flute or indirectly applied to the flute with intervening layers), or the corrugated article can be assembled and then printed upon.

In further detail, and as shown in FIG. 2, an ink set 200 can include a colored ink 204 (ejectable from a printhead associated with container C1) and a black ink 206 (ejectable from a printhead associated with container K). The inks of the ink set can be printed on a print medium 202, such as a printable liner for assembling a corrugated article. There can be more than one colored ink in some examples, e.g., shown in phantom lines at C2 to C6, but there can be as many colored inks as the colorist designs. As an example and without limitation, the ink set may include cyan, magenta, yellow, orange, violet, green, etc. (and black). Any of the colored inks can be considered as the “colored ink” in this example, provided it is not black, gray, or white. In further detail, there may even be multiple black inks as well in some examples, e.g., photo black, gray, matte black, etc. The colored ink (or one or more of the colored inks) can include water, from 1 wt % to less than 5 wt % organic co-solvent, from 1 wt % to 6 wt % organic pigment, and from 0.1 wt % to 3 wt % styrene acrylic resin dispersant having an acid number ranging from 100 mg KOH/g to 160 mg KOH/g. The other details described herein related to the ink compositions with these characteristics are applicable to this ink set. The black ink can include water, a carbon black pigment, and a dispersant. As used herein, “carbon black pigment” refers to an inorganic, water-insoluble, carbon containing black pigment. The water content of the black ink can range from 80 wt % to 99 wt %, from 80 wt % to 90 wt %, from 85 wt % to 95 wt %, or from 90 wt % to 97 wt %. In some examples, the water in the black ink can be deionized, purified, or a combination of deionized and purified. The carbon black pigment can be present at from 1 wt % to 6 wt %, from 1 wt % to 4 wt %, from 1 wt % to 3 wt %, or from 2 wt % to 4 wt %. The dispersant can be any dispersant capable of associating with the carbon black pigment. In one example, the dispersant for the carbon black pigment can be a styrene resin acrylic, and in one example, can be a styrene acrylic resin dispersant having an acid number ranging from 100 mg KOH/g to 160 mg KOH/g. In some examples, the black ink can include any component of the ink composition as describe herein.

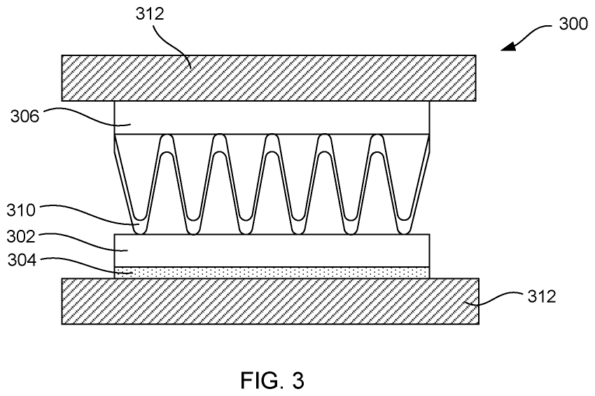

FIG. 3 depicts an example corrugation system 300 where a printable liner 302 with a printed ink composition 304 applied thereto is to be adhered to flute 310 of a corrugated article. Due to the hot corrugation process, the printed ink composition is susceptible to forces and processing conditions that may lead to print media and/or printed ink composition damage, e.g., processing temperatures from 140° C. to 220° C. at 100 to 800 pounds/linear inch (pli) often with some mechanical scraping against the corrugation equipment. In some examples the hot corrugation process can occur at from 150° C. to 205° C., or from 160° C. to 190° C., and the pressures may be from 200 to 600 pli, or from 300 to 500 pli. Other temperatures and pressures can be used. In this example, the flute with a support or base layer 306 (which can also be a second printable liner in some examples) can be adhered to the printable liner, and the hot corrugation process may damage the ink composition if it is not durable at the processing temperatures. For example, in some systems, the printable liner may slide or scrape along one of the hot pressing plates 312 as the corrugated article components are fed into the device or fed to or from another processing step, e.g., adhesive application. With many inks, they are not durable enough to withstand these temperatures, pressures, or mechanical scraping that may occur simultaneously. The high temperature and pressure can further be exacerbated over the peaks of the flute that contact the underside of the printable liner, where there may be more pressure applied than elsewhere on the printable liner, leading to more lateral scraping on the printed ink composition. The ink compositions of the present disclosure can, in many instances, exhibit hot coefficient of friction (CoF) durability that is favorable to this process, resisting unwanted scratching that may be induced by the corrugation process. As another note, the ink compositions of the present disclosure can be printed on other types of media. Corrugation is used by example herein to provide a harsh printing example to demonstrate the durability of the ink compositions of the present disclosure.

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range but also to include all the individual numerical values or sub-ranges encompassed within that range as if each numerical value and sub-range is explicitly recited. For example, a weight ratio range of 1 wt % to 20 wt % should be interpreted to include not only the explicitly recited limits of 1 wt % and 20 wt %, but also to include individual weights such as 2 wt %, 11 wt %, 14 wt %, and sub-ranges such as 10 wt % to 20 wt %, 5 wt % to 15 wt %, etc.

### Examples

The following illustrates examples of the present disclosure. However, it is to be understood that the following is only illustrative of the application of the principles of the present disclosure. Numerous modifications and alternative ink compositions, ink sets, methods, etc., may be devised without departing from the scope of the present disclosure. The appended claims are intended to cover such modifications and arrangements.

### Example 1—Evaluation of Low Concentrations of Organic Co-Solvent(s) on Print Durability

The reduction in the concentration of organic co-solvent(s) in aqueous ink compositions to very low levels, e.g., less than 5 wt %, was investigated with respect to their effect on print durability, including hot coefficient of friction (CoF) durability which is relevant to applications where the ink composition is printed on a printable liner media for application to a flute to form a corrugated board. The ink compositions prepared are provided in Table 1, as follows:

TABLE 1
Varying Organic Co-solvent(s) Concentration

| | | Ink K1 | Ink K2 | Ink K3 | Ink K4 |
|---|---|---|---|---|---|
| Ingredients | Category | (wt %) | (wt %) | (wt %) | (wt %) |
| di-(2-hydroxyethyl)- | Organic | 7-9 | 5-7 | 3-5 | 1-3 |
| 5,5-dimethylhydantoin | Co-solvent | | | | |
| 2-hydroxyethyl-2- | Organic | 0.5-3 | 0.5-3 | 0.5-3 | 0.5-3 |
| pyrollidinone | Co-solvent | | | | |
| DIC PU Hydran ® | Binder | 0.75 | 0.75 | 0.75 | 0.75 |
| RW4601 | | | | | |
| (Straight-chain | | | | | |
| Polyurethane) | | | | | |
| Carbon Black | Pigment | 2.5 | 2.5 | 2.5 | 2.5 |
| Dispersed with | Dispersant | | | | |
| Styrene Acrylic Resin | | | | | |
| Water | Solvent | 83-88 | 85-90 | 87-92 | 89-94 |

Other ingredients include small concentrations of emulsifier, surfactant, biocide, etc.

Four ink compositions prepared in accordance with Table 1 were evaluated for durability under hot CoF durability conditions by individually printing durability plots from the respective four black inks (Inks K1-K4) at 100% area fill. Even though the concentrations of the organic co-solvents are provided within a narrow range, it is noted that the actual four ink compositions tested included a total organic co-solvent content as follows: K1>K2>K3>K4. The hot CoF durability test was conducted by exposing the various printed samples to corrugation temperatures at the higher end of the temperature range, e.g., 400° F. (about 205° C.), typical pressures, and scraping action that can occur during application of a printed liner medium to a flute during the hot corrugation process. Afterwards, the printed samples were cooled and observed for hot CoF durability performance. Inks K1 and K2 performed unacceptably, with white streaks showing through where the scraping occurred at the temperature and pressures described above. Ink K3 performed marginally with respect to hot CoF durability, with some minimal marring and some white liner medium showing through, but not as significantly as that which occurred with Inks K1 and K2. Ink K4 performed the best with essentially no white streaking visible at the printed sample. Only Ink K4 included less than 5 wt % organic co-solvent content, and this is the only printed durability plot that exhibited excellent hot CoF durability.

### Example 2—Evaluation of Organic Co-Solvent(s), Pigment, and Polyurethane Selection on Print Durability

Based on hot CoF durability data collected in Example 1 for Ink K4 (Black Ink with 3.5 wt % organic co-solvent and polyurethane binder), various pigments at various concentrations, e.g., less than 5 wt %, of organic co-solvent were prepared and tested for printability. Specifically, several colored organic pigments and carbon black were evaluated. The pigments were dispersed with styrene acrylic resins of various types, molecular weights, and acid numbers. Table 2 below sets forth the various organic co-solvent(s) evaluated using ink formulations similar to Ink K4 as a base formulation, with the following exceptions: i) the pigment dispersions used were of various colors (or black) with various styrene acrylic resin dispersants evaluated; ii) some ink compositions were prepared with a straight-chain polyurethane binder (Hydran® RW4601 from DIC) as set forth in Table 1, and others were prepared with a graft polyurethane binder (Hydran® RW7581 from DIC); iii) the organic co-solvent components shown in Table 1 were replaced with the organic co-solvent listed below in Table 2 as Inks 1-8 (which are vehicle formulations for inclusion of one of 7 pigment dispersion); iv) some of the pigment concentrations were adjusted to as low as 2.25 wt % (cyan) to as high as 4 wt % (yellow) with other colors adjusted therebetween to provide a balanced full color ink set; v) very minor surfactant concentration adjustments were made within a few tenths of a percent. Notably, since two different polyurethanes were used, there were actually 16 inks prepared the vehicles notated as Inks 1-8. For simplicity, inks with the straight-chain polyurethane (DIC RW4601) are notated with the letter “A,” e.g., Ink 1A, Ink 2A, etc. Inks with the graft-copolymer are noted with the letter “B,” e.g., Ink 1B, Ink 2B, etc. In each case, the water content for the various inks was above 90 wt % for all inks and all colors and black.

TABLE 2
Varying Organic Co-solvent Selection at Low Concentrations

| | Ink 1 | Ink 2 | Ink 3 | Ink 4 | Ink 5 | Ink 6 | Ink 7 | Ink 6 |
|---|---|---|---|---|---|---|---|---|
| Organic Co-solvent | (wt %) | (wt %) | (wt %) | (wt %) | (wt %) | (wt %) | (wt %) | (wt %) |
| ¹ Triethylene Glycol | | 3.5 | — | — | 1.5 | — | — | — |
| ^{1, 2} 2-Hydroxyethyl-2- | 1.5 | — | 3.5 | — | — | — | — | — |
| Pyrrolidone | | | | | | | | |
| ¹ di-(2-hydroxyethyl)- | 2 | — | — | 3.5 | 2 | — | — | — |
| 5,5-dimethylhydantoin | | | | | | | | |
| ² 2-Pyrrolidone | — | — | — | — | — | 3.5 | — | 1.5 |
| ² 5,5- | — | — | — | — | — | — | 3.5 | 2 |
| Dimethylhydantoin | | | | | | | | |
| Organic Co-solvent | 3.5 | 3.5 | 3.5 | 3.5 | 3.5 | 3.5 | 3.5 | 3.5 |
| (Total Added) | | | | | | | | |

¹ includes a hydroxyethyl group
² lactam co-solvent

To test the jetting performance, 112 ink compositions were prepared in accordance with Table 2, e.g., eight different organic co-solvent combinations as shown in Table 2, two different polyurethane binders, and seven different pigments. The various ink compositions were filled in HP thermal inkjet printheads and two metrics were used to evaluate jettability, namely nozzle health and decap performance.

“Nozzle Health” can be evaluated by printing from a print cartridge (experimental print cartridge similar to cartridges used in HP OfficeJet pro 8000 series printer) until the printhead is empty, which typically takes about 60 to 80 pages. Nozzles are monitored to determine the number of missing nozzles at page 1, page 10, page 20, page 40, and page X, which is defined as the last printed page when the ink runs dry. As mentioned, X is typically from 60 to 80 but could be more or less.

“Decap” performance can be measured as time in seconds after which good nozzle health is maintained for the first drop after a period of “waiting” time before the nozzle is fired again. This period of time is the “decap time.” Decap times considered in this data was after 0, 2, 4, 6, 7, 9, and 12 seconds. A longer (or higher) decap time indicates better decap performance.

Nozzle health performance for the 112 inks evaluated is shown in Tables 3A and 3B, and decap performance is shown in Tables 4A and 4B, as follows:

TABLE 3A
Number of Missing Nozzles at page X (or the last printed page)

| | Black | Cyan | Magenta | Yellow | Orange | Violet | Green |
|---|---|---|---|---|---|---|---|
| Ink ID | (K) | (C) | (M) | (Y) | (O) | (V) | (G) |
| Ink 1A | 0 | 1 | 5 | 0 | 3 | 5 | 2 |
| Ink 2A | 6 | 0 | 2 | 1 | 0 | 1 | 1 |
| Ink 3A | 2 | 2 | 3 | 23 | 0 | 2 | 4 |
| Ink 4A | 2 | 3 | 0 | 23 | 0 | 18 | 2 |
| Ink 5A | 1 | 0 | 1 | 32 | 0 | 10 | 0 |
| Ink 6A | 0 | 0 | 0 | 2 | 1 | 0 | 0 |
| Ink 7A | 13 | 30 | 3 | 12 | 5 | 5 | 2 |
| Ink 8A | 26 | 22 | 2 | 5 | 8 | 0 | 7 |

TABLE 3B
Number of Missing Nozzles page X (or the last printed page)

| | Black | Cyan | Magenta | Yellow | Orange | Violet | Green |
|---|---|---|---|---|---|---|---|
| Ink ID | (K) | (C) | (M) | (Y) | (O) | (V) | (G) |
| Ink 1B | 1 | 1 | 2 | 0 | 3 | 7 | 2 |
| Ink 2B | 0 | 0 | 0 | 0 | 1 | 1 | 3 |
| Ink 3B | 0 | 0 | 2 | 2 | 3 | 0 | 5 |
| Ink 4B | 1 | 4 | 0 | 0 | 1 | 1 | 2 |
| Ink 5B | 2 | 3 | 4 | 0 | 0 | 3 | 0 |
| Ink 6B | 2 | 1 | 2 | 0 | 0 | 0 | 5 |
| Ink 7B | 5 | 0 | 4 | 3 | 83 | 63 | 177 |
| Ink 8B | 14 | 0 | 5 | 1 | 72 | 5 | 4 |

TABLE 4A
Decap Performance

| | Black | Cyan | Magenta | Yellow | Orange | Violet | Green |
|---|---|---|---|---|---|---|---|
| Ink ID | (K) | (C) | (M) | (Y) | (O) | (V) | (G) |
| Ink 1A | 0 | 2 | 0 | 0 | 0 | 0 | 0 |
| Ink 2A | 0 | 0 | 0 | 0 | 0 | 0 | 0 |
| Ink 3A | 0 | 0 | 0 | 0 | 0 | 0 | 0 |
| Ink 4A | 2 | 2 | 0 | 0 | 0 | 0 | 2 |
| Ink 5A | 0 | 0 | 0 | 0 | 0 | 0 | 0 |
| Ink 6A | 0 | 0 | 0 | 0 | 0 | 0 | 0 |
| Ink 7A | 0 | 0 | 0 | 0 | 0 | 0 | 0 |
| Ink 8A | 0 | 0 | 0 | 0 | 0 | 0 | 0 |

TABLE 4B
Decap Performance

| | Black | Cyan | Magenta | Yellow | Orange | Violet | Green |
|---|---|---|---|---|---|---|---|
| Ink ID | (K) | (C) | (M) | (Y) | (O) | (V) | (G) |
| Ink 1B | 6 | 7 | 4 | 4 | 7 | 12 | 12 |
| Ink 2B | 7 | 6 | 4 | 4 | 7 | 10 | 12 |
| Ink 3B | 6 | 7 | 4 | 6 | 12 | 12 | 12 |
| Ink 4B | 7 | 6 | 2 | 2 | 7 | 12 | 12 |
| Ink 5B | 7 | 6 | 4 | 6 | 4 | 12 | 12 |
| Ink 6B | 9 | 4 | 2 | 4 | 10 | 12 | 12 |
| Ink 7B | 0 | 0 | 0 | 0 | 0 | 0 | 0 |
| Ink 8B | 0 | 0 | 0 | 0 | 0 | 0 | 0 |

### In Tables 3A, 3B, 4A, and 4B:

Ink Number Indicates Organic Co-solvent(s) from Table 2;

A or B identifies straight-chain (A) or graft (B) polyurethane binder; and

K, C, M, Y, O, V, or G indicates pigment color identity.

### Pigment Dispersion ID for Each Ink:

K includes inorganic Black Pigment w/ styrene acrylic resin dispersant AN153;

C includes organic cyan pigment w/ styrene acrylic resin dispersant AN 179;

M includes organic magenta pigment w/ styrene acrylic resin dispersant AN172;

Y includes organic yellow pigment w/ styrene acrylic resin dispersant AN183;

O includes organic orange pigment w/ styrene acrylic resin dispersant AN114;

V includes organic violet pigment w/ styrene acrylic resin dispersant AN153; and

G includes organic green pigment w/ styrene acrylic resin dispersant AN114.

As seen in Tables 3A and 3B, the nozzle health was comparable across most of the ink compositions, with some organic co-solvent(s) at 3.5 wt % performing better than others. The polyurethane binder also had some impact on nozzle health in some ink formulations, with comb-like or graft polyurethane copolymer performing similarly or in many cases better than the straight-chain polyurethane binder. A few outliers were found with respect to Ink 7B orange, Ink 7B violet, and Ink 7B green, as well as Ink 8 orange, which all exhibited poor nozzle health. This may be related to something more specific with these particular pigments. That stated, though these few outlier ink examples exhibited poor nozzle health in the thermal inkjet printing systems evaluated, they were still thermally inkjettable. There may be other inkjet technologies that could use these particular inks with more success, as they do provide good durability and are stable. In further detail, the CMY inks performed well with both types of polyurethane binder (A and B), and the OVG inks also performed well with only a very few missing nozzles after printing 60 pages, indicating very good jetting performance for the low organic co-solvent ink formulations (other than the outlier exceptions mentioned above).

With respect to decap performance, the data is clearer indicating that the branched polyurethane binder (B) provided improved decap performance over the straight-chain polyurethane binder (A). Most inks with the straight-chain polyurethane had a decap time of 0, indicating poor decap compared to values ranging mostly from 4 to 12 seconds, with a few inks also having poor decap performance, e.g., again mostly with Inks 7 and 8.

Based on details about the organic co-solvent(s) used (at less than 5 wt %) there appears to be a trend toward the use of highly hydrophilic, such as triethylene glycol, 2-hydroxyethyl-2-pyrrolidone, di-(2-hydroxyethyl)-5,5-dimethylhydantoin (Dantocol DHE), and 2-pyrrolidone. Lower hydrophilicity, such as in the case of dimethylhydantoin (structurally similar to Dantocol DHE but without the 2 hydroxyethyl groups) showed poorer decap, even with the comb- or graft-type polyurethane copolymer. Even mixing the dimethylhydantoin with 2-pyrrolidone at the Ink 8 proportions did not help decap performance. Unlike the OVG inks of Ink 7, for CMY inks with the comb- or graft polyurethane copolymer exhibited good nozzle health, but poor decap performance. This poor decap performance can still provide a useful thermal inkjet ink, such as for use with an inkjet printhead with micro-recirculation capability, for example. One of the causes of poor decap performance may be due to evaporation of water from the nozzle when the pen is not printing (idle time), which can result in increased ink viscosity and nozzle blockage due to formation of viscous plug. Printhead with micro-recirculation can be designed such that there is active re-circulation of ink (from bulk ink) in to the firing chamber during non-printing idle time. Thus, micro-recirculation prevents/reduces formation of viscous plug. Thus, even though the inks with straight-chained polyurethane binder all exhibited poor decap performance, those inks with good nozzle health performance could likewise benefit from inkjet printing systems that utilize similar active recirculation or other technologies that are not dependent on good decap performance.

### Example 3—Pigment Stability

Particle size distribution data was collected for the perinone orange pigment from Example 2 using one of two different styrene acrylic resin dispersants. One dispersant had an acid number of 183, which is relatively high, and the other had a lower acid number of 114.

Specifically, to evaluate stability, initial volume average particle size (Mv) was collected using a NanoTrae device for detecting particle size. The perinone orange pigment particle sizes were then determined again using the NanoTrae device after undergoing accelerated shelf-life (ASL) stress at 60° C. for 1 week, 2 weeks, 4 weeks, and 8 weeks. Following the elevated temperature storage period, the samples were allowed to equilibrate to room temperature and the particle sizes were measured (based on a volume averaged particle size). Tables 5A and 5B provides comparative data for the two different types of dispersant.

TABLE 5A
Particle Size Stability (Raw Data)

| | Dispersant | Acid | Ini- | ASL | ASL | ASL | ASL |
|---|---|---|---|---|---|---|---|
| Pigment | Resin | Num- | tial | Week-1 | Week-2 | Week-4 | Week-8 |
| ID | Type | ber | (nm) | (nm) | (nm) | (nm) | (nm) |
| Orange | Styrene- | 183 | 112 | 129 | 137 | 142 | 146 |
| Pigment | acrylic | | | | | | |
| Orange | Styrene- | 114 | 117 | 119 | 119 | 119 | 117 |
| Pigment | acrylic | | | | | | |

TABLE 5B
Particle Size Stability (%Δ is Particle Size)

| | Dispersant | Acid | Ini- | ASL | ASL | ASL | ASL |
|---|---|---|---|---|---|---|---|
| Pigment | Resin | Num- | tial | Week-1 | Week-2 | Week-4 | Week-8 |
| ID | Type | ber | (μm) | (%Δ) | (%Δ) | (%Δ) | (%Δ) |
| Orange | Styrene- | 183 | 112 | 15.18% | 22.32% | 26.79% | 30.36% |
| Pigment | acrylic | | | | | | |
| Orange | Styrene- | 114 | 117 | 1.71% | 1.71% | 1.71% | 0.00% |
| Pigment | acrylic | | | | | | |

As can be seen from Tables 5A and 5B, the particle size is highly stable when using a styrene acrylic resin dispersant having a lower acid number, even after 8 weeks of ASL conditions.

What is claimed is:

1. An ink composition, comprising:
water;
from 1 wt % to less than 5 wt % organic co-solvent;
from 1 wt % to 6 wt % organic pigment; and
from 0.1 wt % to 3 wt % styrene acrylic resin dispersant having an acid number ranging from 100 mg KOH/g to 160 mg KOH/g.

2. The ink composition of claim 1, wherein the water is present in the ink composition at from 90 wt % to 97 wt %.

3. The ink composition of claim 1, wherein the organic co-solvent includes a lactam.

4. The ink composition of claim 1, wherein the organic co-solvent includes a hydroxyethyl group.

5. The ink composition of claim 1, wherein the organic co-solvent has a partition coefficient from −1.4 log P_{1-octanol/water} to −0.1 log P_{1-octanol/water}.

6. The ink composition of claim 1, wherein the organic co-solvent includes 2-pyrrolidinone, 2-hydroxyethyl 2-pyrrolidinone, 5.5-dimethyl hydantoin, ethylhydroxy propanediol, di-(2-hydroxyethy)-5.5-dimethylhydantoin, triethylene glycol, or a combination thereof.

7. The ink composition of claim 1, wherein the organic co-solvent is a combination of 2-hydroxyethyl 2-pyrrolidinone and di-(2-hydroxyethy)-5.5-dimethylhydantoin.

8. The ink composition of claim 1, wherein the styrene acrylic resin dispersant and the organic pigment are present at a weight ratio from 1:10 to 1:2.

9. The ink composition of claim 1, wherein the ink composition further includes from 0.3 wt % to 2 wt % polyurethane binder.

10. The ink composition of claim 1, further comprising a chelating agent selected from 1,3-propylenediiaminetetraacetic acid, ethylenediamine-N,N-disuccinic acid trisodium salt, glutamic acid, N,N-diacetic acid, alpha-alaninediacetic acid trisodium salt, ethyl diglycol, disodium ethanoldiglycine, 4,5-dihydroxy-1,3-benzenesulfonic acid, or a combination thereof.

11. An ink set, comprising:
a colored ink, including:
water,
from 1 wt % to less than 5 wt % organic co-solvent,
from 1 wt % to 6 wt % organic pigment, and
from 0.1 wt % to 3 wt % styrene acrylic resin dispersant having an acid number ranging from 100 mg KOH/g to 160 mg KOH/g; and
a black ink, including:
water,
a carbon black pigment, and
a dispersant.

12. The ink set of claim 11, wherein a water content of the colored ink is from 90 wt % to 97 wt %.

13. The ink set of claim 11, wherein the dispersant for the carbon black pigment is a styrene resin acrylic dispersant having an acid number ranging from 100 mg KOH/g to 160 mg KOH/g.

14. A method of printing, comprising jetting an ink composition onto a media substrate, the ink composition, including water, from 1 wt % to less than 5 wt % organic co-solvent, from 1 wt % to 6 wt % organic pigment, and from 0.1 wt % to 3 wt % styrene acrylic resin dispersant having an acid number ranging from 100 mg KOH/g to 160 mg KOH/g.

15. The method of printing of claim 14, wherein the media substrate is a printable liner and the method further includes applying the printable liner to a flute of a corrugated article using a hot corrugation process at from 140° C. to 220° C.
